(19) United States
(12) Patent Application Publication
(10) Pub. No.: US 2012/0156350 A1
(43) Pub. Date: Jun. 21, 2012

(54) COOKING VESSEL

(76) Inventors: Edward A. GATES, Lafayette, LA (US); Daniel L. Moultrie, Vestavia Hills, AL (US)

(21) Appl. No.: 13/328,692

(22) Filed: Dec. 16, 2011

Related U.S. Application Data
(60) Provisional application No. 61/423,892, filed on Dec. 16, 2010.

(51) Int. Cl. A47J 37/04; A23L 1/315

(52) U.S. Cl. 426/523; 99/419

(57) ABSTRACT

The invention provides an improved cooking vessel design that can be used to easily employ a combustible fuel to produce reliably cooked and acceptable food products, especially poultry and chicken products.

### REFERENCE TO RELATED APPLICATIONS

This application claims priority benefit of U.S. Provisional application no. 61/423,892 filed Dec. 16, 2010, the entire contents of which are hereby incorporated by reference.

### FIELD OF THE INVENTION AND INTRODUCTION

In one embodiment the invention relates to a cylindrically shaped cooking device with improved characteristics and that provides a reliable and easy to use method for outdoor cooking. The device employs an airflow system and suspension system allowing ideal cooking conditions without requiring constant monitoring or handling during cooking. While a cylindrical shape is preferred, it is not required.

### BRIEF SUMMARY OF THE INVENTION

The invention encompasses a cooking or heating device in one of several shapes, where the device is sized to allow the user to cook multiple whole poultry or chickens at one time. The air flow design, causing air to flow into the lower air vents or holes and out the top or lid air vents or holes at approximately the same rate, provides sufficient and sustainable oxygen supply for a charcoal mass to burn at slow-cooking temperatures. This allows the user to set up the apparatus with poultry or chicken, ignite the charcoal, and leave the device essentially unattended for hours until cooking is complete, usually about 4 hours. In some embodiments, the cooking vessel aspect of the device is in the form of a cylinder or standard shipping drum or barrel, such as a 55 gallon barrel (or steel drum), 30 gallon barrel, or 15 gallon barrel. The cooking vessel is raised off the ground by one or more wheels or legs, and positioning off the ground aids the air flow conditions for proper cooking. A number of hangers can be inserted into the upper lip of the barrel in order to position hangers to hang poultry or chicken at a desired distance from the charcoal heat source. While charcoal is noted as the preferred heat source, charcoal in combination with wood or other combustibles may also be acceptable. In the 55 gallon embodiment, the length of the hanger is optimally about 17 or 18 inches, so that the approximate center point of the poultry or chicken is hanging at a distance from the heat source. In the 30 gallon embodiment, the hanger is approximately 11 inches in length, and in the 15 gallon embodiment, the hangar is approximately 7 inches in length.

Accordingly, the invention in one aspect includes a cylindrical cooking device comprising a cylindrical vessel with a cylindrical interior space and a top end accommodating a lid and a bottom end accommodating a removable heat source tray. One or more supports, legs or wheels are positioned at the bottom for holding the bottom end of the vessel off the ground during heating and cooking. The top end of the vessel comprises hanger connection points, such as notches, slits or cut-outs, to accommodate one or more hanger rails that fit into the connection points. The hanger rails provide a surface for hanging a plurality of hangers into the interior of the vessel. At the bottom end of the vessel is space for a removable heat source tray, such as a charcoal tray. The charcoal tray can be fitted or designed with handles for ease of use. A removable lid closes the top end of the cylindrical vessel, and preferably has a handle, and is sized and shaped to substantially prevent smoke from leaving the vessel during cooking. The vessel includes a plurality of vent holes near the bottom end of the cylinder and positioned at approximately the height of the heat source or charcoal. Preferably, each vent is equally spaced around the circumference of the cylindrical vessel or the exterior. To allow efficient airflow, a second set of vent holes are positioned at or near the top of the vessel or through the lid, and again preferably spaced apart from one another. The vent holes can be regulated by optional sliding or closing mechanisms, such as a damper or daisy wheel dampers. To promote optimum heating and cooking, the total area or volume of the vent holes near the bottom of the cylindrical vessel equals the total area or volume of vent holes in the top and lid.

The cylindrical vessel can be a number of different sizes, but is conveniently sized as one of the common shipping drums available commercially, such as approximately the size of a 55 gallon drum, a 30 gallon drum, or a 15 gallon drum. When the cylindrical vessel is the size of a 55 gallon drum, the number of bottom vent holes can be six or about six and each bottom vent hole can be approximately 1 inch in diameter, and the number of lid vent holes can be six and each can be approximately 1 inch in diameter. In this embodiment of a 55 gallon size, the length of the hanger from the hanger rail to the point at which the hanger engages a poultry or chicken is approximately 17 or 18 inches.

In an optional embodiment, the cooking device can be configured or designed to be easily shipped, such as having a square or rectangular or other cross-sectional shape, or by using a cylinder shape that is in two or more parts, where the parts that can be assembled into a substantially fixed or air-tight cooking vessel. In any embodiment, the plurality of hangers can each have a length so that the distance between the hanger rail and the lower surface of a poultry or chicken hanging on the hanger is approximately 4 inches. In preferred examples of these embodiments, a rectangular shaped vessel is used where opposing sides are collapsible or foldable so that the vessel can be collapsed or folded into a more convenient size when not in use. In another example, a circular or ellipsoid shape is used and one or more sides contain an integrated connections along the length of the side to allow the user to disassemble the vessel. The connections can be a hinge, or tongue-in-groove, sliding, or other connection that preferably is capable of maintaining a substantially airtight configuration when assembled for cooking.

The invention also encompasses methods of cooking poultry or chicken comprising providing a device as described here. The method can include filling the heat source tray with combustible, food-compatible fuel, such as charcoal as used in the food preparation industry, to a level that is approximately four inches from the lower surface of the poultry or chicken, igniting the fuel, hanging one or more poultry or chicken on a hanger from the hanger rails, and closing the lid. The method can use a cylindrical vessel that is approximately a 55 gallon drum, the amount of fuel can be approximately 8 lbs, and the cooking time can be approximately 4 hours.

Without limiting the scope of the invention, the following drawings and descriptions provide examples of the invention.

### BRIEF DESCRIPTION OF THE DRAWINGS

FIG. 1 is a cut-away view of one example showing interior of cooking vessel, placement of charcoal tray, charcoal, lower vent holes, air flow through vent holes, chickens, hangers, and top or lid vent holes.

FIG. 2 is a drawing of a 55 gallon example showing the outside of the vessel with lower vent hole placement, front legs, and cleanout door.

FIG. 3 is a drawing of an embodiment showing the outside of vessel with rear wheel assemblies and moving handle.

FIG. 4 is a drawing of a lid design, showing lid handle and the air vent placement.

FIGS. 5A and 5B are close-up views showing exemplary hanger rail placements and notches in rim or lip of top of cylinder.

FIGS. 6A and 6B are views of the exemplary hanger rails and the connections to cylinder.

FIGS. 7A and 7B are views showing an alternative connection for hanger rails.

FIGS. 8A and 8B depict hanger positions on the hanger rails.

FIG. 9 depicts the charcoal tray and tray lifting handles and foot tabs at bottom.

FIG. 10 depicts the charcoal tray and lift handles as situated inside the cooking vessel and off of the bottom surface of the vessel.

FIGS. 11 and 12 show additional embodiments. In FIG. 11, the vessel is composed of two parts that fit together securely to form a cylinder. In FIG. 12 the rectangular form can be collapsed or dissembled into small pieces, but assembled into a secure and substantially air-tight vessel. The additional rack on the top of both the FIGS. 11 and 12 embodiments is optional.

FIG. 13 depicts another embodiment where three sections of a cylinder are stacked and connected to form the cooking vessel.

FIG. 14 depicts an optional lid configuration for the cylindrical vessels showing sliding closures in the air vent to control amount of air flow.

FIGS. 15-17 depict examples of the three section of the fully assembled cylinder as separate parts. FIG. 17 shows the bottom section with stand or legs to keep cylinder above ground. FIG. 16 depicts the center and FIG. 15 the top section.

FIG. 18 depicts an optionally door in the lower section of the cylinder form.

FIG. 19 is a top view of an assembled three section cooking vessel with hanger rails.

FIG. 20 is a cutaway view of an exemplary lower section of the three section cooking vessel.

### DETAILED DESCRIPTION OF EXEMPLARY EMBODIMENTS

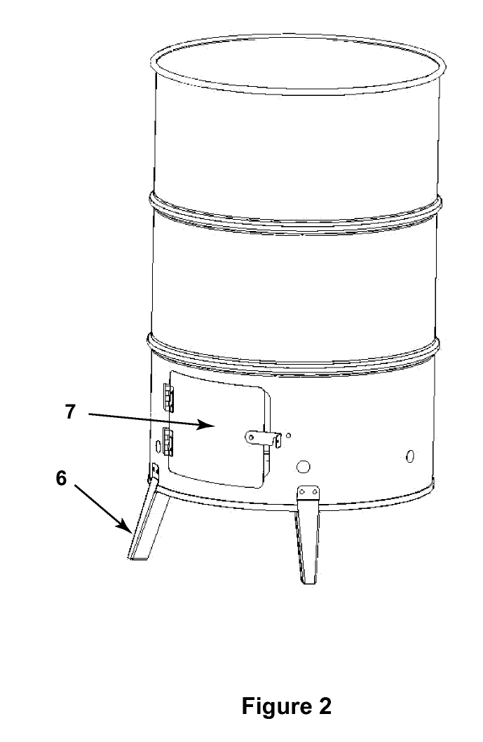

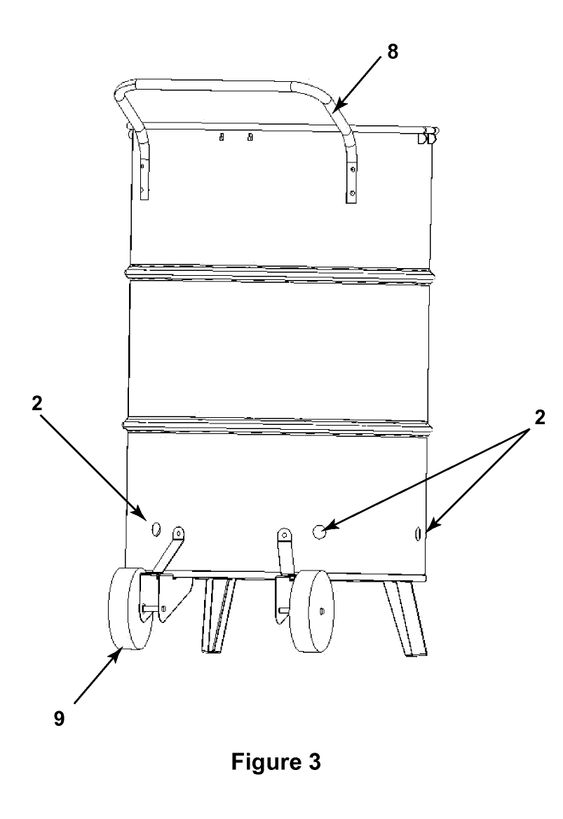

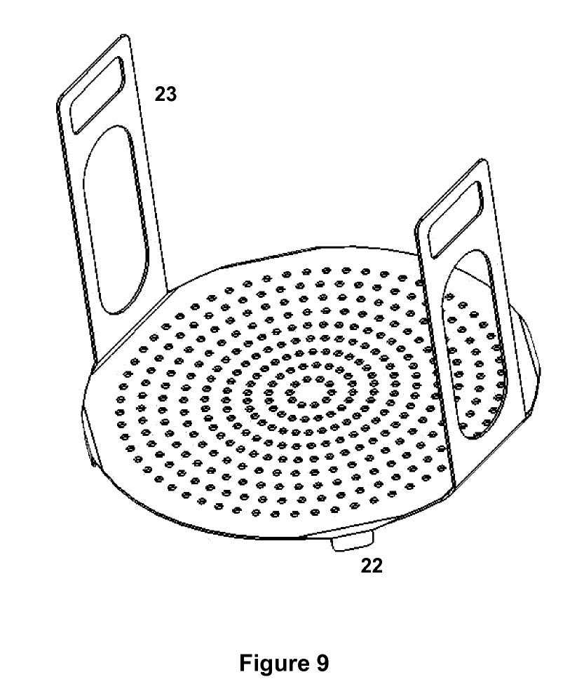

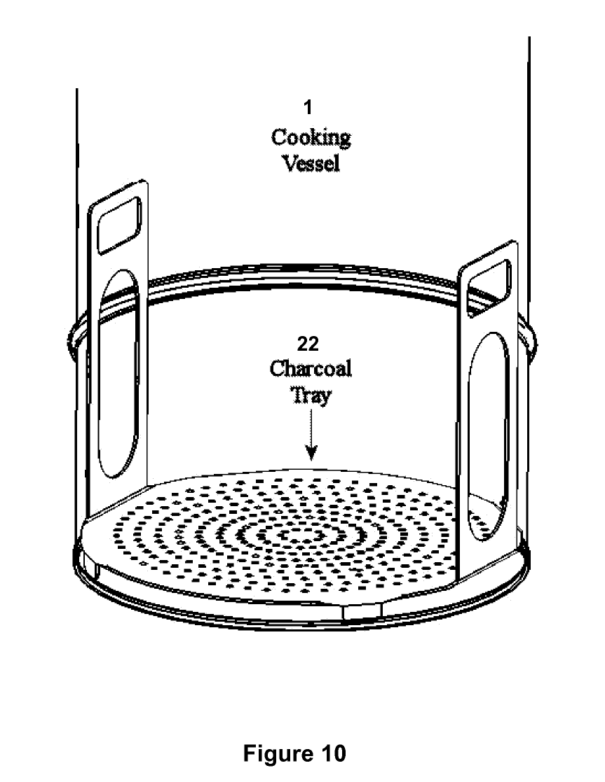

The invention includes a cooking vessel (1), preferably a cylindrical vessel (C), and raised above the ground, as by a set of 2 legs (6) (FIG. 2) on one side and two wheels (9) (FIG. 3) on the other side. The cylinder is thus held in a vertical position for cooking. The support to raise the cylinder off the ground generally should be tall enough to allow air flow underneath the cooking vessel to prevent overheating, and to prevent burning to anything below the vessel. The vessel contains a charcoal tray (22) in FIGS. 9-10, preferably made of perforated steel or expanded metal. In optimum conditions, the tray sits 1 inch off the bottom of the vessel and includes spacer elements or studs to keep the tray of the bottom surface of the vessel.

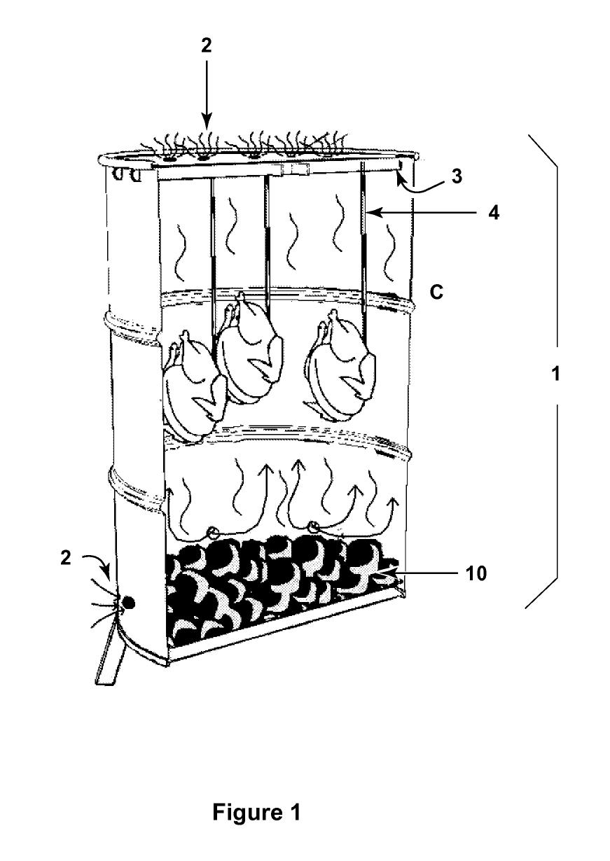

The design, total volume of, and placement of the vent or air holes allows sufficient air into and out of the vessel in order to maintain the combustion by heat source. In the 55 gallon drum embodiment, the vessel has six 1 inch diameter vent holes (2) at FIG. 1, which are evenly spaced around the circumference of the vessel, and at about 3.5 inches above the interior bottom level. The height of these vent holes are set to allow air flow across the top of the charcoal bed during operation. The vessel has a diameter large enough to accommodate approximately 6 to 8 lbs of charcoal (10) (FIG. 1) in a layer approximately 2.5 to 3 inches deep that sit on the charcoal tray.

For optimum heating or cooking, the 55 gallon drum embodiment should be filled with approximately 8 lbs of charcoal, and the 30 gallon drum embodiment is filled with approximately 6 lbs of charcoal. Levels of charcoal or heat source that are too low will not heat the interior properly, and levels too high will also be detrimental to cooking. The levels listed above generally result in a distance between the heat source and the poultry or chicken of approximately 4 inches. Also, they generally result in a 2 inch or larger layer of charcoal, if charcoal is the desired heat source.

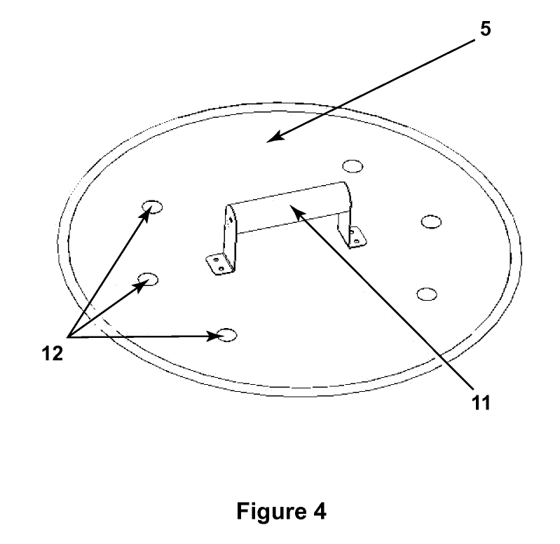

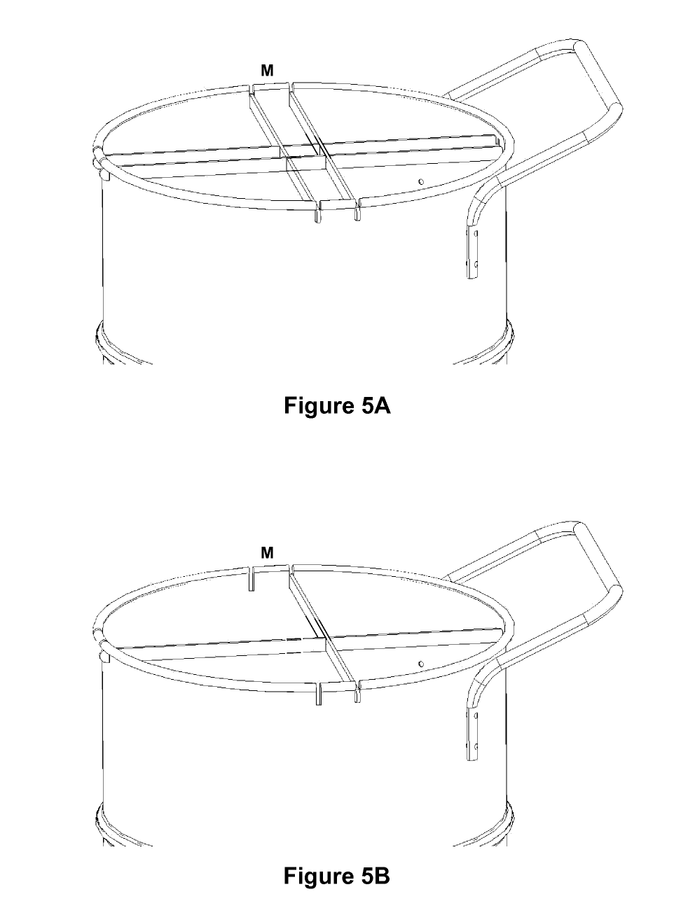

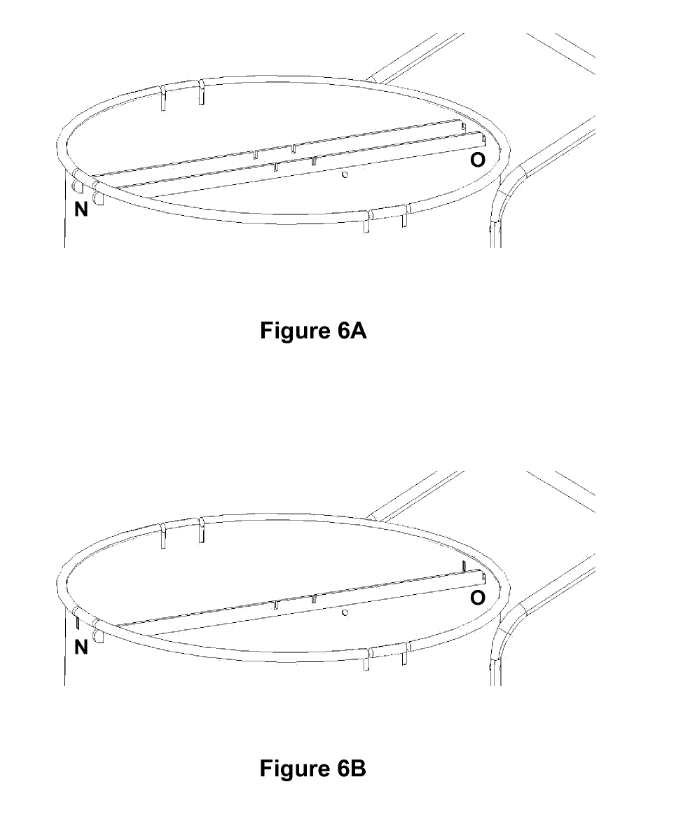

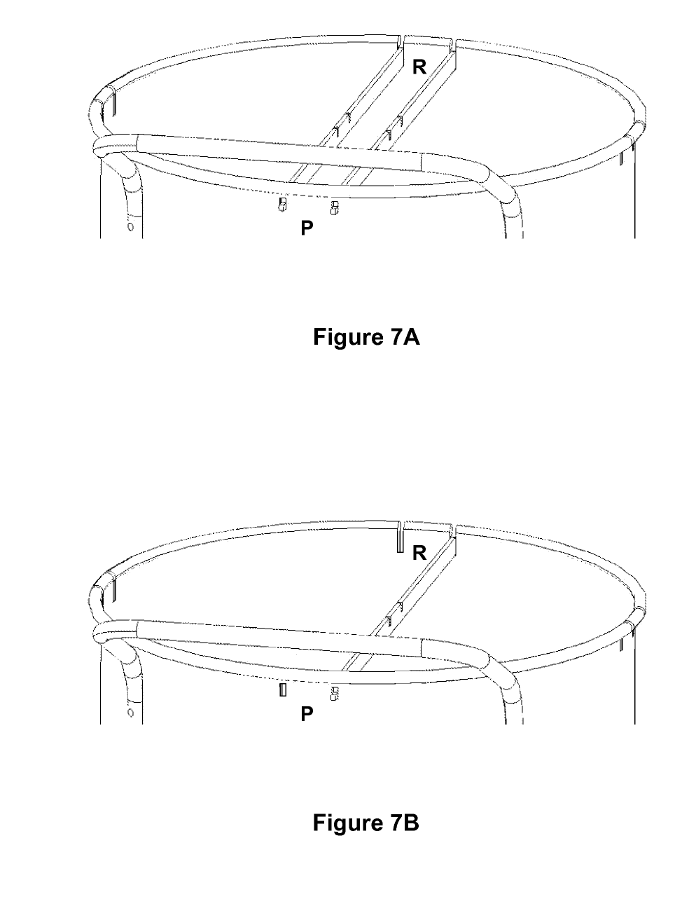

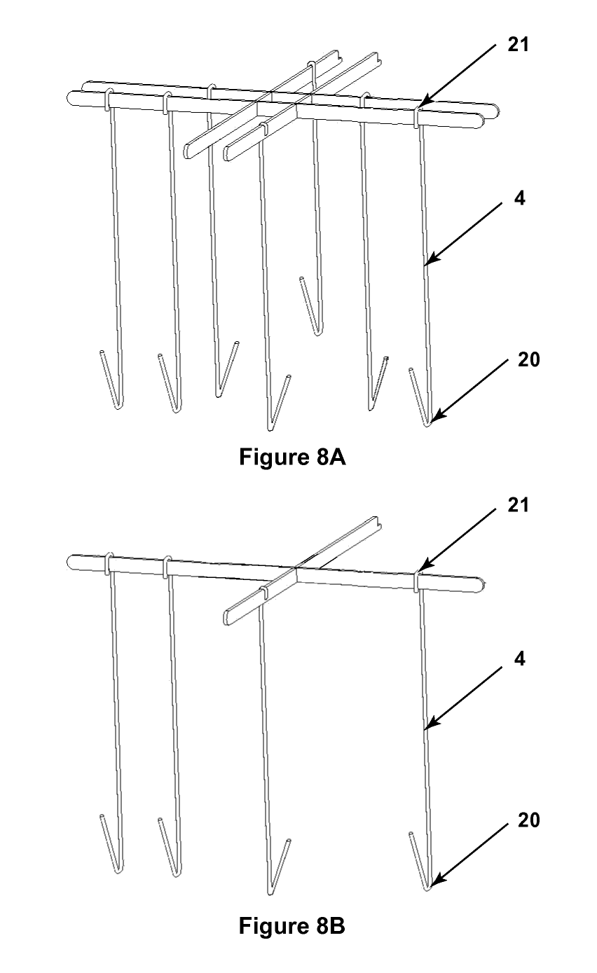

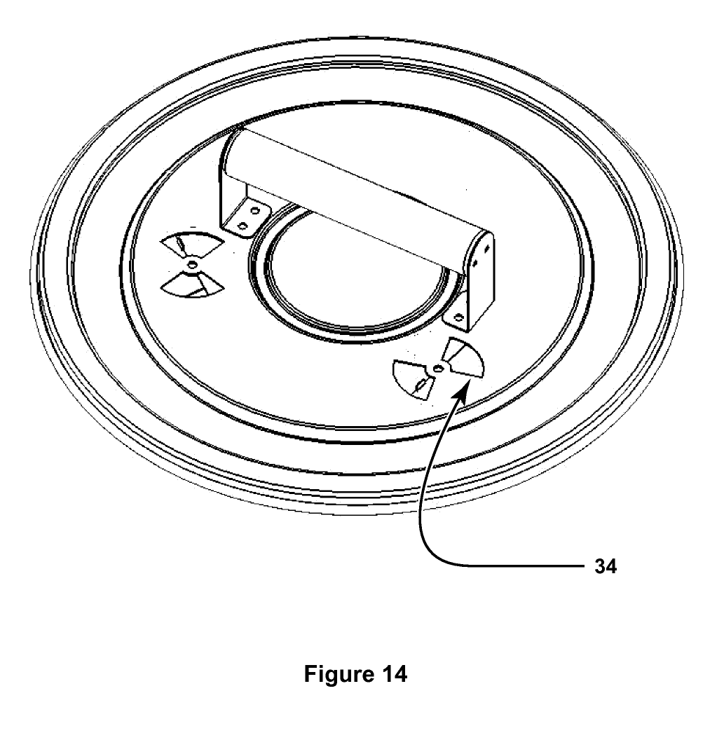

The vessel can incorporate an integral cleanout door (7) in the bottom third of the vessel to facilitate ash cleanout. The vessel has included a plurality of hangers, such as a set of 12 hangers (FIG. 8) made of steel wire or similar, non-combustible material, to facilitate hanging whole or partial chickens, poultry or other food at a designated height from the top surface of the charcoal bed. As discussed herein, the length of these wires can be important to optimum operation. The top of the hangers (21) are fashioned so that they hang on hanger rails (3) (FIG. 1) and (M) (FIG. 5) that span the diameter of the vessel in one or two or more directions, whose ends rest in notches incorporated into the vessel's top lip (FIGS. 5A-B, 6A-B, 7A-B). The manner of connection to the top area is optional and take one of several forms, such as shown in (R), (P), (O), and (N) of FIGS. 6A-B and 7A-B. The vessel includes a lid (5) (FIG. 4) made to match the diameter and outside circumference of the vessel such that it forms a seal when positioned on the vessel. The lid can incorporate a handle consisting of a wood dowel (11) (FIG. 4) between steel risers that will help to minimize the heat soak into the handle making it safer for the lid to be lifted by hand. The lid can also incorporate 6×1 inch vent holes (12) positioned around a circumference (FIG. 4). In one aspect and preferred embodiment, the combined area of the upper vent holes or vent holes in the upper area and lid of the vessel substantially match the area of the lower vent hole (i.e., sq/in area) to allow the same amount of air out as is allowed to come in. In other embodiments, the amount of air flow in and/or out can be adjusting during cooking through sliding closures (34) (FIG. 14) placed at one of more of the vent holes.

When set up correctly with the appropriate amount of charcoal, the charcoal is ignited and allowed to reach a state at which the coals are glowing with no remaining visible flame. The chickens, food or poultry are then hung on the hangers and the hangers are hung on the hanger rails. The chickens or partial chickens can be hung at any location along the lengths of the hanger rails. Once all chicken or partial chickens are in place, the lid is set onto the vessel. No further action is required by the operator until the chickens are fully cooked. The apparatus and process is unique in that it allows one or many chickens to be cooked without attendance until they are fully cooked and adequately smoked. The meat is not dried out or overcooked. It is still juicy yet fully cooked.

A perforated metal or wire-surface charcoal tray can be designed that is sized to fit the inside diameter of the cooking vessel and placed in the bottom of the cooker (FIG. 9). It is held off the bottom with 1 inch integrated foot tabs (22) so air can circulate under the burning charcoal or heat source. Charcoal is then placed evenly across the entire tray to a depth not to exceed the bottom edge of the 6 vent holes.

The charcoal tray has as part of its fabricated assembly two lift handles (23) that allow the user to lift the tray out of the cooking vessel for cleaning. The handles are long so that the user does not have to reach beyond half way down inside the barrel.

As noted for the 55 gallon embodiment, one inch diameter vent holes evenly spaced around the circumference of the cooking vessel can be used. The vent holes are located to optimize air flow across the charcoal to provide optimum heat and air ratio sufficient to cook chickens evenly.

The hangers (FIG. 8A-B) for hanging chickens or poultry can be manufactured to a desired length to achieve optimum cooking height from the coals and to provide correct cooking temperature to thoroughly cook up to 12 chickens in the 55 gallon embodiment. The hangers can have a loop structure (21) or other form to attach securely to hanger rails and also a hook area at bottom (20).

The hanger support rails can be mounted around top lip of cooking vessel (FIG. 5A-B, 6A-B). Hanger support rails strategically placed to allow for up to 12 chickens to be placed in cooking vessel. Rails are mounted into vessel in such a way as to hold them solidly in place and not allow them to come unseated as individual hangers are inserted or removed.

The lid can incorporate six 1 inch holes whose area equals that of the lower vent holes. The holes provide air and heat escape to help maintain an even heating inside the cooking vessel. The holes can be evenly spaced and oriented so that they are not an encumbrance to the user when using the lid handle to move the lid.

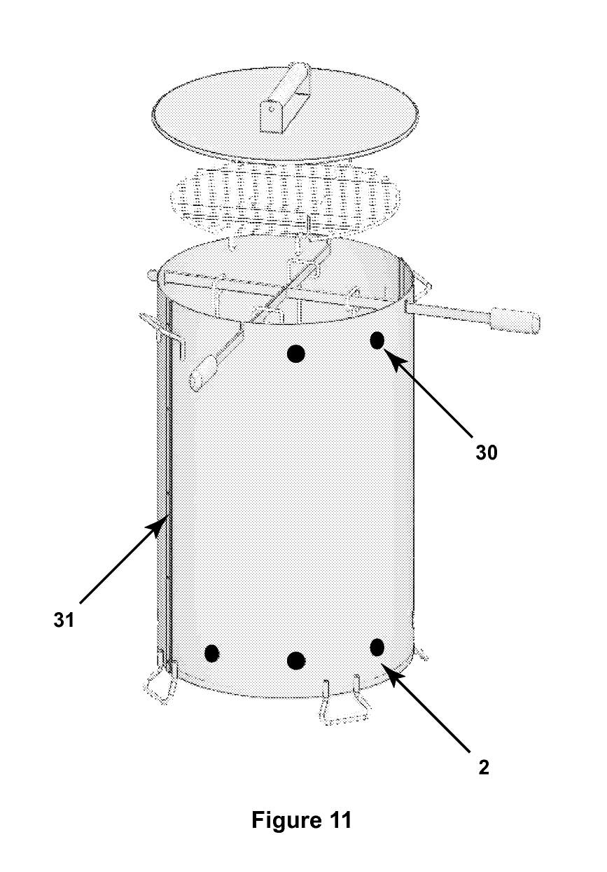

In additional embodiments, the vents (30) and location of the vents at the top and in the lid can be varied (FIGS. 11, 12, 14). As noted above, the operator can select and open vents at the bottom and top areas of the vessel so that the flow of air into the bottom of the vessel is substantially the same as the flow of air out the top.

In a preferred embodiment, the cooking vessel is supported in the front by two fabricated legs (6) (FIG. 2). These legs are designed to provide vertical and horizontal stability of the cooking vessel. The legs are of a length sufficient to provide for air flow under the cooking vessel to help prevent accidental ignition and burning of anything under the cooking vessel.

The cooking vessel can be supported in the rear by wheel assemblies (9) (FIG. 3). These are added to facilitate moving the apparatus around without having to lift it. The wheel assemblies are set to share the vertical load with the front legs as well as maintain the stability of the unit in the upright position. They are set at a wheel diameter and height to maintain the air flow capabilities under the cooking vessel.

The apparatus can incorporate an ash cleanout door near the bottom of the vessel (7) (FIG. 2). This door allows access to the interior of the unit for cold ash removal once cooking is done and fire is out. In some embodiments, the door can also include an adjustable damper, or daisy wheel damper (34), to allow air flow at the bottom.

The apparatus can include an attached handle made of tubular steel and mounted to the cooking vessel in two places with screws and nuts (8) (FIG. 3) or other secure connection. The handles provide a means for the operator to safely and securely maneuver the apparatus without having to handle the exterior of the cooking vessel itself.

The lid can incorporate a lifting handle comprised of two steel risers and a wooden cylindrical rod (11) (FIG. 4) connecting the two. The wooden rod is arranged between the two risers so as to form a gripping handle with which to maneuver the lid. In this embodiment, vent holes in lid (12) are spaced around lid (5) (FIG. 4).

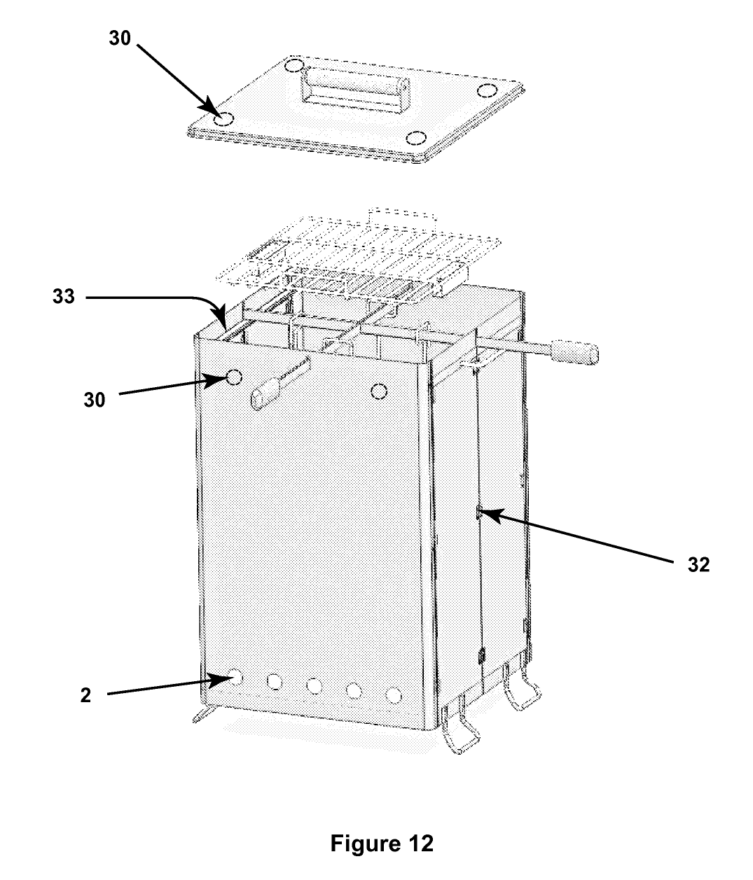

FIGS. 11 and 12 depict collapsible or foldable cooking vessels. FIG. 11 shows a seam (31) that separates two sections of the vessel cylinder. This seam can be a sliding hinge-type connection, tongue and groove connection, or other connection that securely fastens the two or more sections of the cylinder together. Preferably, once connected, the parts of the vessel form a substantially airtight vessel, but this is not required. As noted elsewhere, vents at top (30) and bottom (2) can be positioned to allow adequate flow of air through interior of vessel. FIG. 12 shows a foldable side (32) with seam. The opposite side, not shown, can also have a folding seam. The two sides can collapse to allow the operator to fold these sides in and/or out. Alternatively, the sides can slide apart so that the vessel can be separated into multiple parts for shipping or storage. Support piece (33) maintains solid shape during cooking. Again, vent holes (2) and (30) (here shown as dotted optional locations for top area and lid) are integrated into design.

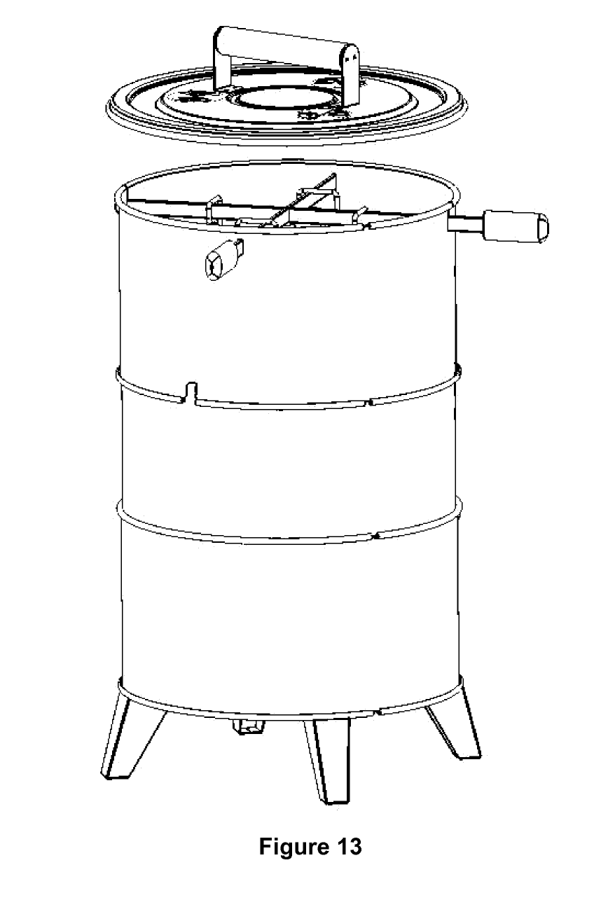

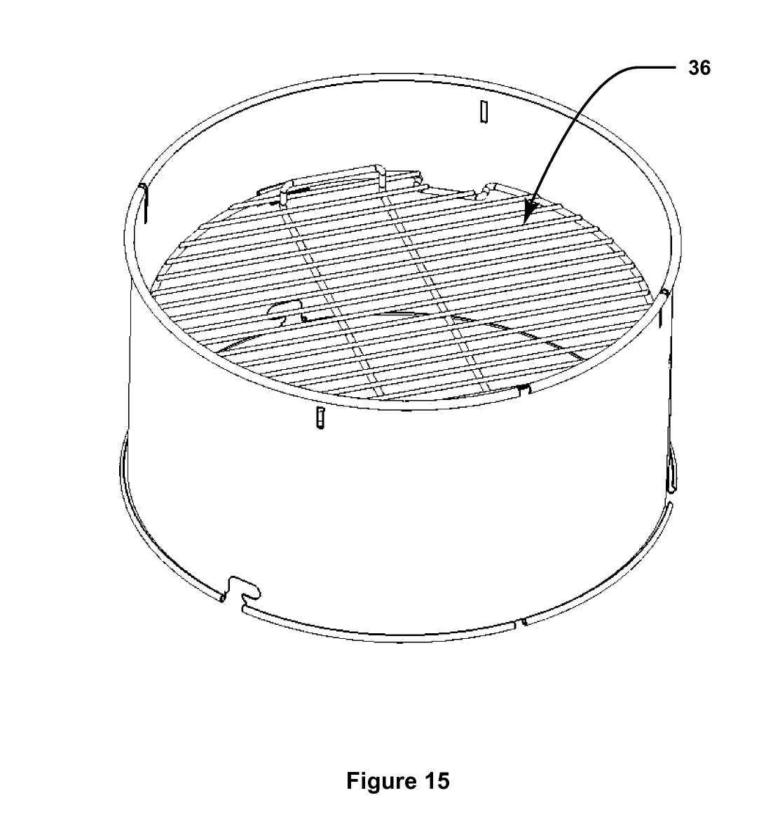

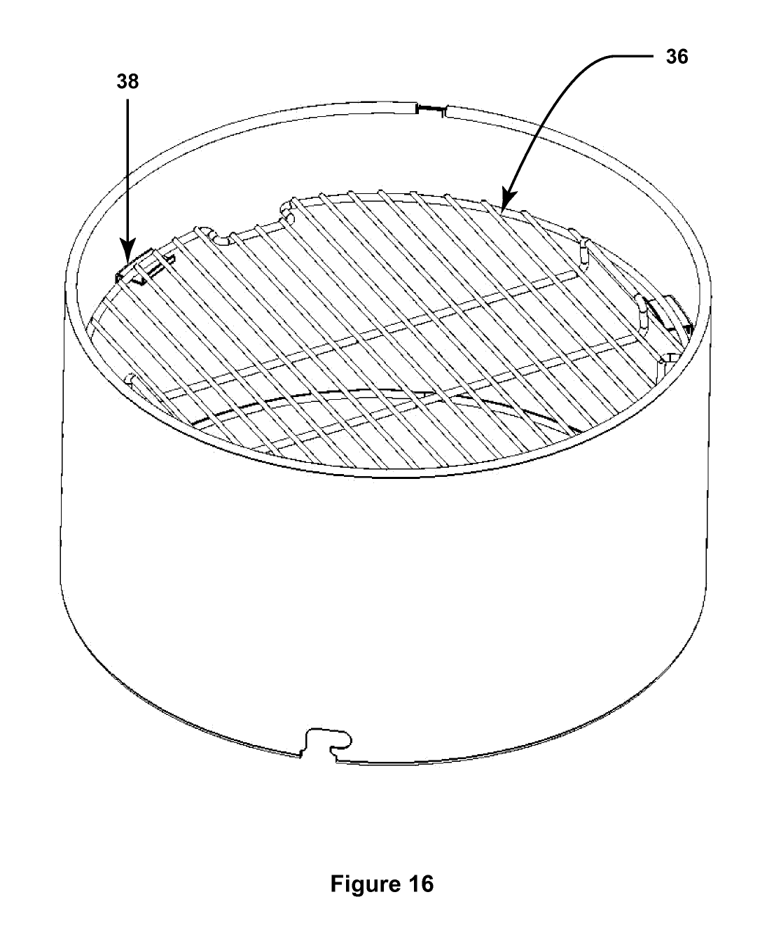

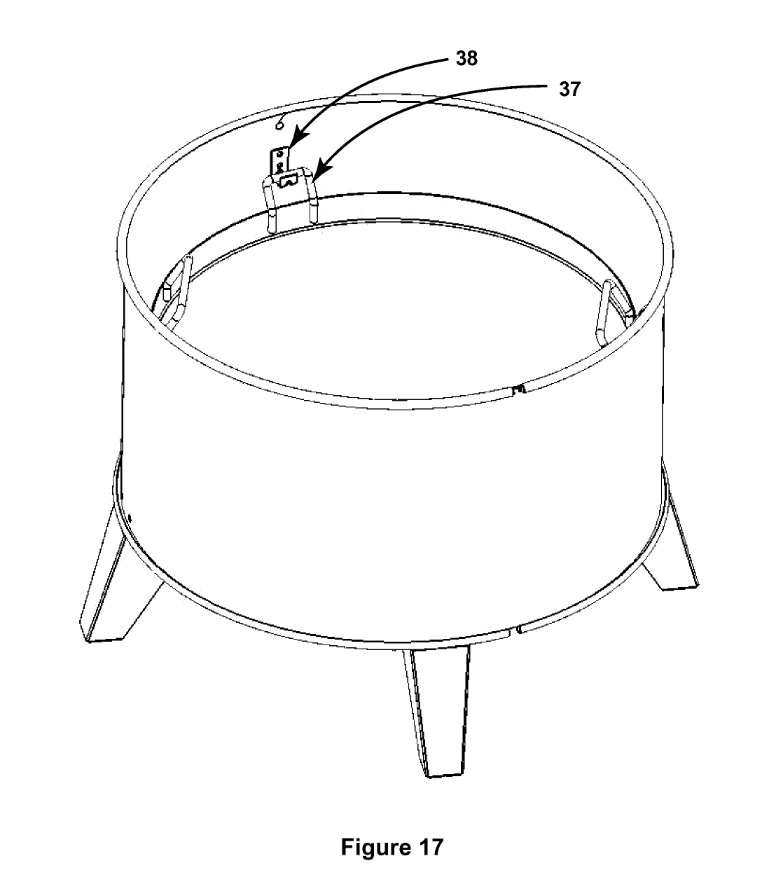

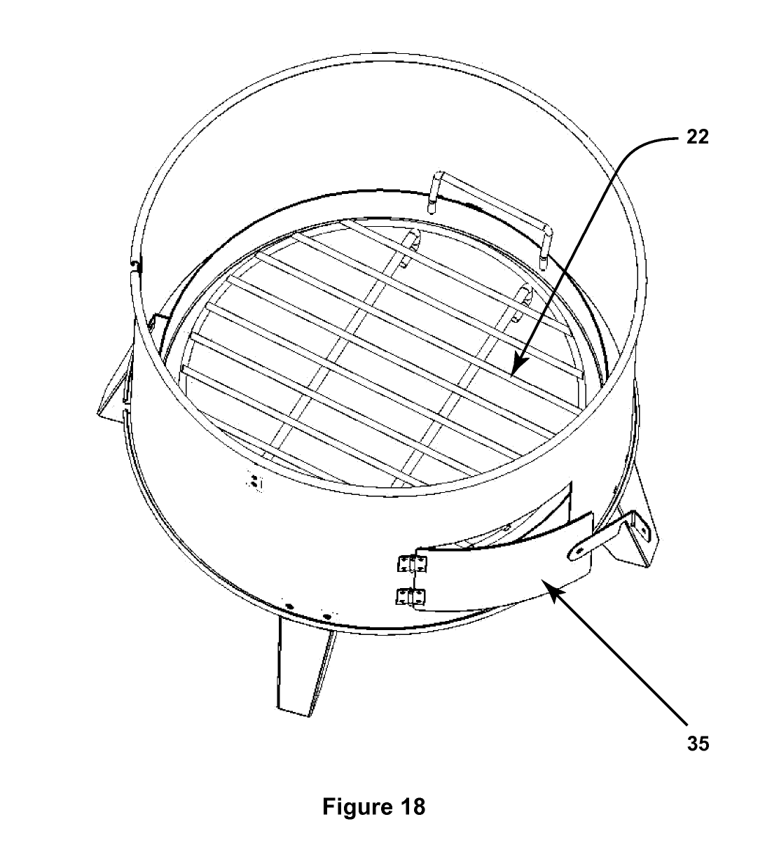

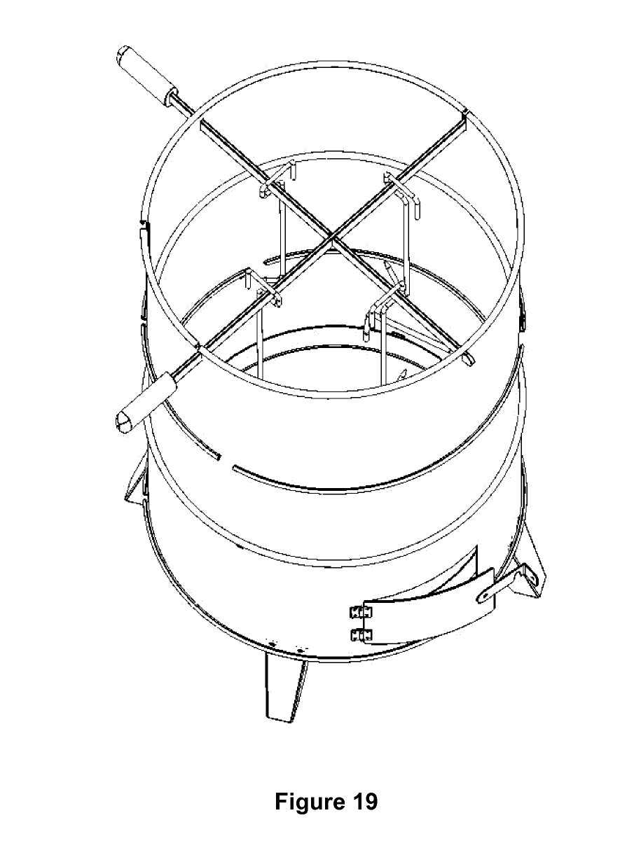

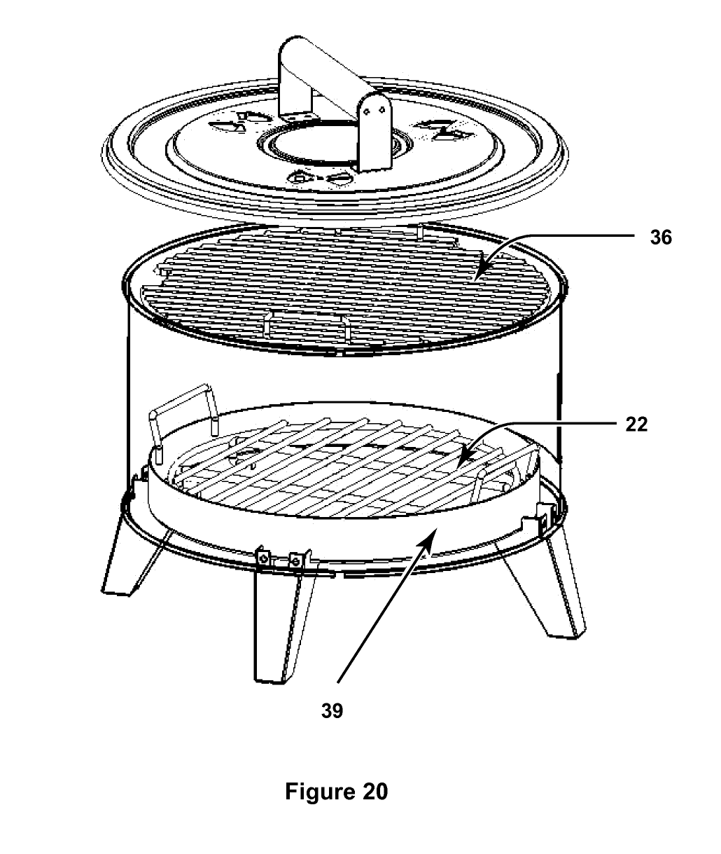

An additional embodiment is shown in FIGS. 13-20 with a three section cylindrical vessel. FIGS. 13 and 19 show the vessel constructed for cooking. FIG. 14 shows lid with optional sliding closures, or daisy wheel dampers, on vent holes (34). FIGS. 15-17 show each of the three cylindrical sections of the vessel. FIG. 18 depicts charcoal or combustion source tray (34) in lower part and door (35). FIG. 17 depicts another view with tabs (38) for holding handles of tray (37). FIGS. 15 and 16 show other sections of cylinder with optional tray (36) and tabs (38) for holding food to be cooked. Connections to attach each section to another can be seen at the bottom of sections shown in FIGS. 15 and 16. FIGS. 13 and 19 depict the fully assembled embodiment with hanger rails at top.

Although only a few embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A cylindrical cooking device comprising:
a cylindrical vessel with a cylindrical interior space and a top end accommodating a lid and a bottom end accommodating a removable heat source tray;
a support for holding the bottom end of the vessel off the ground during heating and cooking;
hanger connection points at the top end of the cylinder;
a plurality of hanger rails that fit into the connection points at the top end of the cylinder and that provide a surface for hanging a plurality of hangers into the interior of the vessel;
a removable heat source tray;
a lid for closing the top end of the cylindrical vessel;
a plurality of vent holes near the bottom end of the cylindrical vessel and positioned at approximately the height of the heat source, each vent equally spaced around the circumference of the cylindrical vessel;
and a plurality of vent holes in the top of the cylinder or lid spaced apart from one another, wherein the total area of the vent holes near the bottom of the cylindrical vessel equals the total area of vent holes in the top and lid.

2. The device of claim 1, wherein the cylindrical vessel is approximately the size of a 55 gallon drum, a 30 gallon drum, or a 15 gallon drum.

3. The device of claim 1, wherein the cylindrical vessel is the size of a 55 gallon drum, the number of bottom vent holes is six and each bottom vent hole is approximately 1 inch in diameter.

4. The device of claim 3, wherein there are six vent holes in the lid and each is approximately 1 inch in diameter.

5. The device of claim 2, wherein the cylinder is in two parts that can be assembled into a substantially fixed or air-tight cooking vessel.

6. The device of claim 3, wherein the length of the hanger from the hangar rail to the point at which the hanger engages a poultry or chicken is approximately 17 or 18 inches.

7. The device of claim 1, wherein the plurality of hangers each has a length so that the distance between the hanger rail and the lower surface of a poultry or chicken hanging on the hanger is approximately 4 inches.

8. A method of cooking poultry or chicken comprising providing a device as claimed in one of claim 1 or 3, filling the heat source tray with combustible, food-compatible fuel to a level that is approximately four inches from the lower surface of the poultry or chicken, igniting the fuel, hanging one or more poultry or chicken on a hanger from the hanger rails, and closing the lid.

9. The method of claim 8, wherein fuel is substantially charcoal, the size of the cylindrical vessel is approximately a 55 gallon drum, the amount of fuel is approximately 8 lbs, and the cooking time is approximately 4 hours.

10. A collapsible cooking device comprising:
a vessel with an interior space and a top end accommodating a lid and a bottom end accommodating a removable heat source tray;
an exterior support for holding the bottom end of the vessel off the ground during heating and cooking;
hanger connection points at the top end of the vessel;
a plurality of hanger rails that fit into the connection points at the top end of the vessel and that provide a surface for hanging a plurality of hangers into the interior of the vessel;
a removable heat source tray;
a lid for closing the top end of the vessel;
a plurality of vent holes near the bottom end of the vessel and positioned at approximately the height of the heat source, each vent equally spaced around the exterior of the vessel;
and a plurality of vent holes in the top of the vessel and/or the lid or the vessel, the vent holes spaced apart from one another, wherein the total area of the vent holes near the bottom of the vessel is approximately equal to the total area of vent holes in the top and lid;
wherein the vessel is composed of two or more sections that can be connected along one or more seams to form a substantially airtight vessel.
